(19) United States
(12) Patent Application Publication
(10) Pub. No.: US 2020/0211084 A1
(43) Pub. Date: Jul. 2, 2020

(54) SYSTEM AND METHOD FOR HEALTHCARE PRODUCT RECOMMENDATION

(71) Applicants: Jayant Lokhande, Torrance, CA (US); Sonali Lokhande, Torrance, CA (US)

(72) Inventors: Jayant Lokhande, Torrance, CA (US); Sonali Lokhande, Torrance, CA (US)

(21) Appl. No.: 16/233,806

(22) Filed: Dec. 27, 2018

(51) Int. Cl. G06Q 30/06; G06F 16/955; G09B 19/00

(52) U.S. Cl. CPC G06Q 30/0631; G09B 19/0092; G06F 16/9558

(57) ABSTRACT

A system and method for healthcare product recommendations are described. The system selects, organizes, and presents the best dietary/nutrition/lifestyle products available from around the globe for specific health conditions and/or lifestyle changes/enhancements from a platform that is simple and easy to understand/navigate. The system selects the primary dietary supplement product for the principal health care condition in context by analyzing various selected brands, their product quality in terms of ingredients, formulation process, price and utility value promised. The system then selects the one single primary product for sale based on the aforementioned criteria. The system further selects a secondary product for associated health care condition based on the aforementioned criteria. The system also has an inbuilt e-commerce platform for online purchases and logistics.

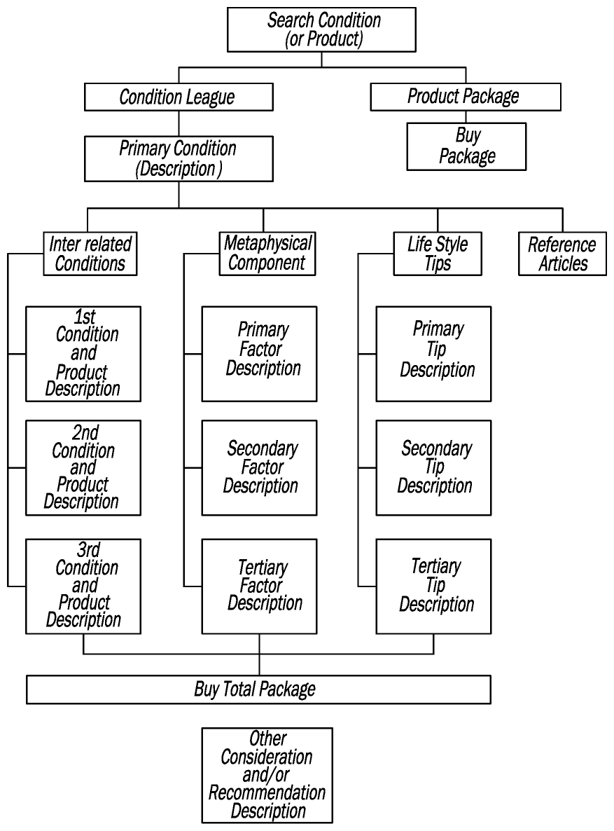

### FIELD OF THE INVENTION

The present invention in general relates to dietary/nutrition/lifestyle supplement products, vitamins, phytochemicals, botanical extracts, medical foods, functional foods and beverages, over the counter medications, skin care, and/or the like. The present invention in particular relates to a system and method which selects, organizes, and presents the best dietary supplement products available from around the globe for specific health conditions.

### BACKGROUND OF THE INVENTION

All physiological systems in living organisms work in tandem. No physiological system in living organisms functions alone. This system biology and or pharmacology approach is also applicable in health care conditions. Such integrated physiological network determines the fate and scope of health disorders. For example, the trigger of Alzheimer's or Dementia might be in the liver. Thus, treatment of the liver with dietary supplements along with actual Alzheimer's support dietary supplements is a smart way forward for treatment. In the same case, Alzheimer's is also connected with eye disorders and insomnia but, as such, discreet in nature. So, treatment of such disorders and insomnia will give an upper hand in management of Alzheimer's disease.

Secondly, nowadays there are multiple buying options available for consumers in nutritional and dietary supplements and personal healthcare products. However; the consumer is not always sure as to which branded product is a value purchase. The quality of these products is primarily dependent on the ingredients being used, the formulation process, price and its utility value. For example, curcumin requires fats as a media for the best absorption in human body. Therefore, liposomal curcumin is the best choice than its capsule or tablet forms.

The average consumer's education and/or awareness is usually inadequate to understand the above mentioned factors at the time of buying the best health care products and hence most of the times the consumers are not able to make the best buying choice for nutritional and dietary supplements and do not gain any value for price. Conventionally, consumers get themselves educated through healthcare magazines, articles, educational videos, media, banners, posters, conferences, trade shows, wellness speakers, health coaches, life-style coaches, store category managers, and mainstream health care system.

Consumers buy health care and personal care products either through retail stores and or online shops depending on inputs offered by the above mentioned sources. The consumers thus end up making buying choices dependent on how much they are aware and/or educated and how are they oriented towards buying.

When a consumer walks in a retail point of purchase, there are several hundred brands available for single health care condition and/or representative product and the store category manager is unable to suggest any real product or health care management advice due to various factors. The retail prices also vary as per market and or shop structure. Empirically, most of health care and personal care products brands are influenced by socio-economic-political-cultural-environmental factors and don't keep customer's value in central focus. Because of this, consumers do not usually get the best-unbiased advice and/or suggestion for their buy of nutritional and dietary supplements.

On the other hand, online shopping choice is primarily based on reviews, feedbacks, blogs and posts and there are several different conclusions one can arrive at and hence it is difficult to conclude which brand option to opt for. Most healthcare practitioners do not make use of the concept of system pharmacology while suggesting or advising on healthcare and personal care products.

U.S. Patent Application Publication No. 2007/0174085 discloses a system and method for the bid-based ranking of search results, in particular, of healthcare products selected based on symptoms or problems and optionally constraints.

U.S. Patent Application Publication No. 2010/0145886 discloses a product evaluation and selection process for consumer products. The process includes demonstrating the effectiveness of consumer product on consumer skin by comparing actual images of skin treated with product to images of skin that were artificially transformed. The process also includes the assignment of a symbol associated with a difference in product performance where the symbol may be used to aid consumers in selecting product.

U.S. Patent Application Publication No. 2001/0037215 discloses a medical, educational, and home healthcare materials distribution system for enabling medical subscribers to provide the best available diagnosis-related products to clients.

### OBJECTS OF THE INVENTION

The primary object of the invention is to provide a system which selects, organizes, and presents the best dietary/nutrition/lifestyle products available from around the globe for specific health conditions and/or lifestyle changes/enhancements based on systems pharmacology.

A further object of the invention is to provide a system with an extensive database of healthcare conditions and dietary supplement products for the user to select from.

A further object of the invention is to provide a system for selecting the best dietary supplement product for a chosen health care condition along with the products for associated health care conditions.

### SUMMARY OF THE INVENTION

Before the present invention is described, it is to be understood that the present invention is not limited to particular methodologies and materials described, as these may vary as per the person skilled in the art. It is also to be understood that the terminology used in the description is for the purpose of describing the particular embodiments only, and is not intended to limit the scope of the present invention.

The present invention describes a system integration of health conditions system pharmacology mapping. It addresses the management of principal health care condition in context with its other connected conditions. While choosing the principal dietary supplement product for principal health care condition in context the system analyzes various selected brands, their product quality in terms of ingredients, formulation process, price and utility value promised and the system chooses the one single product for sale. The same product selection process is applied for other connected disorders in context with principle health care condition in question and one single product is chosen for sale. Product and functional merits of the chosen products and their value are determined. Other meta-physical causes of the selected principal health condition are also determined to suggest any life style changes which will help in increasing the effectiveness of the suggested dietary supplements. Further, the system also has an online library of relevant and meritorious research articles with their hyperlink to educate the consumers on health conditions, their science, and research with respect to the selected principal health care condition.

In accordance with one embodiment of the present invention, a method is provided for healthcare products recommendation to a user, comprising the steps of:

selecting a health care condition;

determining health care products for the condition;

selecting one primary product from the determined products based on a plurality of criteria;

determining associated healthcare conditions and metaphysical components of the condition;

selecting one secondary product for the associated condition; and

displaying the primary product and secondary product to the user.

In accordance with one aspect of this embodiment, the method further comprises the step of providing a database of health care conditions and health care products.

In accordance with one aspect of this embodiment, the plurality of criteria for selection of one primary product and one secondary product is selected from the group consisting of brands of the products, the product quality in terms of ingredients, formulation process of the product, price of the product and utility value of the product and combinations thereof.

In accordance with one aspect of this embodiment, the method further comprises the step of providing an online library of relevant research articles and their hyperlinks to educate the consumers on health conditions, their science, and research with respect to the selected health care condition.

In accordance with one aspect of this embodiment, the method further comprises the step of providing an inbuilt e-commerce platform for online purchases and logistics.

In accordance with one aspect of this embodiment, the user can buy the selected primary and secondary products alone or together from the e-commerce platform.

In accordance with another embodiment of the present invention, a system is provided for healthcare products recommendation to a user, comprising:

a sub-system for selecting a health care condition;

a sub-system for determining health care products for the condition;

a sub-system for selecting one primary product from the determined products based on a plurality of criteria;

a sub-system for determining associated healthcare conditions and metaphysical components of the condition;

a sub-system for selecting one secondary product for the associated condition; and

a sub-system for displaying the primary product and secondary product to the user.

In accordance with one aspect of this embodiment, the system further comprises a database of health care conditions and health care products.

In accordance with one aspect of this embodiment, the plurality of criteria for selection of one primary product and one secondary product is selected from the group consisting of brands of the products, the product quality in terms of ingredients, formulation process of the product, price of the product and utility value of the product and combinations thereof.

In accordance with one aspect of this embodiment, the system further comprises an online library of relevant research articles and their hyperlinks to educate the consumers on health conditions, their science, and research with respect to the selected health care condition.

In accordance with one aspect of this embodiment, the system further comprises further comprises an inbuilt e-commerce platform for online purchases and logistics.

In accordance with one aspect of this embodiment, wherein the user can buy the selected primary and secondary products alone or together from the e-commerce platform.

### BRIEF DESCRIPTION OF THE DRAWINGS

The present invention, together with further objects and advantages thereof, is more particularly described in conjunction with the accompanying drawing in which:

The Figure is a flow chart describing the system and method of healthcare product recommendation in accordance with the general teachings of the present invention.

### DETAILED DESCRIPTION OF THE INVENTION

Before the present invention is described, it is to be understood that this invention is not limited to particular methodologies described, as these may vary as per the person skilled in the art. It is also to be understood that the terminology used in the description is for the purpose of describing the particular embodiments only, and is not intended to limit the scope of the present invention. Throughout this specification, the word “comprise,” or variations such as “comprises” or “comprising,” will be understood to imply the inclusion of a stated element, integer or step, or group of elements, integers or steps, but not the exclusion of any other element, integer or step, or group of elements, integers or steps. The use of the expression “at least” or “at least one” suggests the use of one or more elements or ingredients or quantities, as the use may be in the embodiment of the invention to achieve one or more of the desired objects or results.

The present invention is a system which selects, organizes, and presents the best dietary/nutrition/lifestyle products available from around the globe for specific health conditions and/or lifestyle changes/enhancements from a platform that is simple and easy to understand/navigate. The invention does not diagnose any user conditions and neither offers any pharmaceuticals/regulated drugs but rather the system offers specific navigation with relationship to others such as conscious, subconscious and products categories to show a complete representation of how particular health conditions can relate to each other and/or what products may be associated with each other.

The present invention describes a system integration of health conditions system pharmacology mapping. The system and the method are outlined in the form of a flow chart in the Figure. The system addresses the management of principal health care condition in context with its other connected conditions by suggesting the best available dietary supplement product. The system of the present invention comprises of an index of healthcare conditions as per system pharmacology, a listing of selected products for respective healthcare conditions and a listing of associated products for other connected health conditions. The user of the system selects a product or a health care condition from the exhaustive database of dietary supplement products or health care conditions respectively. The system then conducts a product search or a health condition search depending on the input command it receives. For instance, if the user conducts a health condition search, the system then selects the best available dietary supplement product for the selected health condition.

While choosing the principal dietary supplement product for principal health care condition in context, the system analyzes various selected brands, their product quality in terms of ingredients, formulation process, price and utility value promised. A primary product is a product for health condition in context and a secondary product is a product for Inter related health conditions to primary health condition. The system then selects the one single primary product for sale based on the aforementioned criteria. This same product selection process is applied for other connected disorders in context with principle health care condition in question and one single secondary product for inter related health conditions is chosen for sale. Product and functional merits of the chosen products and their value are determined. Other meta-physical causes of the selected principal health condition are also determined to suggest any life style changes which will help in increasing the effectiveness of the suggested dietary supplements. Further, the system also has an online library of relevant and meritorious research articles with their hyperlink to educate the consumers on health conditions, their science, and research with respect to the selected principal health care condition. The system also has an option for monthly subscription of the supplement products for their users.

As mentioned earlier, the dietary supplement products are selected, organized, and presented from across the world and only one final supplement product is shortlisted for the user. For example, there are over 1000 “Vitamin C” branded products around the world. In order to select one product, the user requires doing a lot of research and lot of time is utilised. Conventional use of search engines (GOGGLE, BING, and/or the like) perhaps displays millions of results; and it becomes difficult for users to select one out the million options. The system of the present invention helps in identifying the single best Vitamin C product and only offers that product as an individual product purchase which is time efficient.

In the given embodiment of the present invention, the system also has an inbuilt e-commerce platform for online purchases and logistics. Unlike the current method of searching and finding individual products, either on same or different websites and adding them separately into a shopping cart, the system of the present invention offers the users a quick (One Click) buy option to put the entire selected pack into the shopping cart. Users also have an option to buy individual products.

In some applications, the present invention described above may be provided as elements of an integrated software system, in which the features may be provided as separate elements of a computer program. Some embodiments may be implemented, for example, using a computer-readable storage medium (e.g., non-transitory) or article which may store an instruction or a set of instructions that, if executed by a processor, may cause the processor to perform a method in accordance with the embodiments. Other applications of the present invention may be embodied as a hybrid system of dedicated hardware and software components. Moreover, not all of the features described above need be provided or need be provided as separate units. Additionally, it is noted that the arrangement of the features do not necessarily imply a particular order or sequence of events, nor are they intended to exclude other possibilities. For example, the features may occur in any order or substantially simultaneously with each other. Such implementation details are immaterial to the operation of the present invention unless otherwise noted above.

The exemplary methods and computer program instructions may be embodied on a computer readable storage medium (e.g., non-transitory) that may include any medium that can store information. Examples of a computer readable storage medium (e.g., non-transitory) include electronic circuits, semiconductor memory devices, ROM, flash memory, erasable ROM (EROM), floppy diskette, CD-ROM, optical disk, hard disk, fiber optic medium, or any electromagnetic or optical storage device. In addition, a server or database server may include computer readable media configured to store executable program instructions. The features of the embodiments of the present invention may be implemented in hardware, software, firmware, or a combination thereof and utilized in systems, subsystems, components or subcomponents thereof.

Furthermore, a software program embodying the features of the present invention may be used in conjunction with a computer device or system. Examples of a computing device or system may include, but are not limited to, an electronic book reading device, a computer workstation, a terminal computer, a server computer, a handheld or mobile device (e.g., a tablet computer, a personal digital assistant “PDA”, a mobile telephone, a Smartphone, etc.), a web appliance, a network router, a network switch, a network bridge, any machine capable of executing a sequence of instructions that specify an action to be taken by that machine, and any combinations thereof. In one example, a computing device may include and/or be included in, a kiosk.

As used herein, the term “mobile device” is intended to encompass any form of programmable computing device as may exist, or will be developed in the future, that implements a communication module for wireless voice and data communications, including, for example, cellular telephones, personal data assistants (PDA's), palm-top computers, laptop, and notebook computers, wireless electronic mail receivers (e.g., the BLACKBERRY and TREO devices), multimedia Internet enabled cellular telephones (e.g., the BLACKBERRY STORM, and similar personal electronic devices that include a wireless communication module, processor and memory.

The computer device or system may also include an input device. In one example, a user of the computer device or system may enter commands and/or other information into computer device or system via an input device. Examples of an input device may include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. The input device may be interfaced to bus via any of a variety of interfaces including, but not limited to, a serial interface, a parallel interface, a game port, a USB interface, a FIREWIRE interface, a direct interface to bus, and any combinations thereof. The input device may include a touch screen interface that may be a part of or separate from the display.

A user may also input commands and/or other information to the computer device or system via a storage device (e.g., a removable disk drive, a flash drive, etc.) and/or a network interface device. A network interface device, such as network interface device may be utilized for connecting the computer device or system to one or more of a variety of networks and/or one or more remote devices connected thereto. Examples of a network interface device may include, but are not limited to, a network interface card (e.g., a mobile network interface card, a LAN card), a modem, and any combination thereof. Examples of a network may include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software, etc.) may be communicated to and/or from the computer device or system via a network interface device.

The computer device or system may further include a video display adapter for communicating a displayable image to a display device, such as a display device. Examples of a display device may include, but are not limited to, a liquid crystal display (LCD), a cathode ray tube (CRT), a plasma display, a light emitting diode (LED) display, and any combinations thereof. In addition to a display device, the computer device or system may include one or more other peripheral output devices including, but not limited to, an audio speaker, a printer, and any combinations thereof. Such peripheral output devices may be connected to a bus via a peripheral interface. Examples of a peripheral interface may include, but are not limited to, a serial port, a USB connection, a FIREWIRE connection, a parallel connection, and any combinations thereof.

While considerable emphasis has been placed herein on the specific elements of the preferred embodiment, it will be appreciated that many alterations can be made and that many modifications can be made in preferred embodiment without departing from the principles of the invention. These and other changes in the preferred embodiments of the invention will be apparent to those skilled in the art from the disclosure herein, whereby it is to be distinctly understood that the foregoing descriptive matter is to be interpreted merely as illustrative of the invention and not as a limitation.

What is claimed is:

1. A method for healthcare products recommendation to a user, comprising the steps of:
selecting a health care condition;
determining health care products for the condition;
selecting one primary product from the determined products based on a plurality of criteria;
determining associated healthcare conditions and metaphysical components of the condition;
selecting one secondary product for the associated condition; and
displaying the primary product and secondary product to the user.

2. The method as claimed in claim 1, further comprising the step of providing a database of health care conditions and health care products.

3. The method as claimed in claim 1, wherein the plurality of criteria for selection of one primary product and one secondary product is selected from the group consisting of brands of the products, the product quality in terms of ingredients, formulation process of the product, price of the product and utility value of the product and combinations thereof.

4. The method as claimed in claim 1, further comprising the step of providing an online library of relevant research articles and their hyperlinks to educate the consumers on health conditions, their science, and research with respect to the selected health care condition.

5. The method as claimed in claim 1, further comprising the step of providing an inbuilt e-commerce platform for online purchases and logistics.

6. The method as claimed in claim 5, wherein the user can buy the selected primary and secondary products alone or together from the e-commerce platform.

7. A system for healthcare products recommendation to a user, comprising:
a sub-system for selecting a health care condition;
a sub-system for determining health care products for the condition;
a sub-system for selecting one primary product from the determined products based on a plurality of criteria;
a sub-system for determining associated healthcare conditions and metaphysical components of the condition;
a sub-system for selecting one secondary product for the associated condition; and
a sub-system for displaying the primary product and secondary product to the user.

8. The system as claimed in claim 7, further comprising a database of health care conditions and health care products.

9. The system as claimed in claim 7, wherein the plurality of criteria for selection of one primary product and one secondary product is selected from the group consisting of brands of the products, the product quality in terms of ingredients, formulation process of the product, price of the product and utility value of the product and combinations thereof.

10. The system as claimed in claim 7, further comprising an online library of relevant research articles and their hyperlinks to educate the consumers on health conditions, their science, and research with respect to the selected health care condition.

11. The system as claimed in claim 7, further comprising an inbuilt e-commerce platform for online purchases and logistics.

12. The system as claimed in claim 11, wherein the user can buy the selected primary and secondary products alone or together from the e-commerce platform.
